(19) United States
(12) Patent Application Publication
(10) Pub. No.: US 2021/0222086 A1
(43) Pub. Date: Jul. 22, 2021

(54) COMPOSITIONS AND THEIR USE

(71) Applicant: Linkage Technology Switzerland SA, Geneve (CH)

(72) Inventors: Libin Sun, Nanjing City (CN); Su Yang, Nanjing City (CN); Xinhan Zhu, Nanjing City (CN)

(21) Appl. No.: 16/965,527

(22) PCT Filed: Jan. 23, 2020
(86) PCT No.: PCT/EP2020/051688

§ 371 Date: Jul. 28, 2020

(30) Foreign Application Priority Data
Jan. 23, 2019 (CN) 201910062215.9
Feb. 1, 2019 (GB) 1901413.3

(51) Int. Cl. C11D 3/08; C11D 17/00; C11D 1/14; B08B 3/08; C11D 11/00

(52) U.S. Cl. CPC C11D 3/08; C11D 17/003; C11D 11/0023; B08B 3/08; C11D 1/143

(57) ABSTRACT

The present invention is directed to a cleaning formulation. The formulation is in particular intended to be utilised in a “waterless” context, which means that no additional water (besides any water that may already be contained in the formulation) is necessary in order to achieve cleaning.

### FIELD OF INVENTION

The present invention is directed to a cleaning formulation. The formulation is in particular intended to be utilised in a “waterless” context, which means that no additional water (besides any water that may already be contained in the formulation) is necessary in order to achieve cleaning. The field of application relates to substantially non-absorbent surfaces such as metal, plastic, leather, stone, minerals, painted and coated surfaces, some woods and glass, for instance. A particularly preferred application is for the cleaning of vehicles (interior and, especially, exterior).

### BACKGROUND OF THE INVENTION

Most cleaning formulations currently available on the market require the use of a large volume of additional water—for example, in order to make up a larger volume of cleaning solution, to dilute a concentrated cleaning solution, or to rinse off residues after a cleaning solution has been applied and used.

Clean water is a precious resource and a lack of clean water to meet demand is listed by the World Economic Forum as the largest global risk in terms of potential impact over the next decade.

In order to minimise this risk, there is a need to reduce the use and contamination of water in all kinds of processes. Cleaning is one area where large quantities of water are used and subsequently contaminated with various cleaning agents. This water must be cleaned before it can be used again. Vehicle cleaning (such as car cleaning) is a good example of an area where large quantities of water are used and contaminated with various chemical agents.

Formulations for waterless cleaning of vehicles have been put forward previously but have not in general led to acceptable cleaning properties. In particular removal of dirt, shine of the final surface and storage stability have not generally been acceptable.

WO 2018/045925 A1 describes a formulation that cleans without need for additional water to dilute or rinse the cleaning formulation (i.e. a waterless cleaning formulation). This formulation can pull dirt off a surface. It is not necessary to use additional water to rinse the dirt away. Water is thereby saved.

The applicant has found that cleaning formulations made according to this publication have room for improvement, in particular as regards their temperature stability.

### SUMMARY OF THE INVENTION

According to a first aspect of the invention, there is provided a formulation for cleaning comprising:

solvent; and
one or more surfactants;
silicate selected from magnesium lithium silicates and mixtures thereof;
wherein the silicate is present in an amount in the range 0.01 to 0.5 wt %.

In a second aspect of the invention, there is provided a formulation for cleaning comprising:

solvent;
silicate selected from the group consisting of
silicate of formula H₂LiMgNaO₁₂Si₄,
silicate of formula M_{w}EₓSi_{y}O_{z}.aH₂O, wherein M is an alkali metal and E is an alkaline earth metal;
wherein w, x, y and z are all numbers (usually integers) greater than 0 and wherein a is 0 or integer number (usually an integer) greater than 0;
and mixtures thereof;
wherein silicate is present in a total amount in the range 0.01 to 1.5 wt %, preferably 0.01 to 0.5 wt %.

In a third aspect of the invention, there is provided a formulation for cleaning comprising
solvent, preferably water;
silicate present in an amount in the range 0.01 to 1.5 wt %, preferably 0.01 to 0.5 wt %;
at least one polymer;
   wherein the formulation has a viscosity of at least 20 mPa·s, preferably at least 28 mPa·s, measured at a shear rate of 11.3 cm/s and a temperature of 20° C.

In a fourth aspect of the invention, there is provided a method of cleaning a surface, comprising the following steps:

(a) providing the present cleaning formulation;
(b) applying the undiluted cleaning formulation to the surface.

In a fifth aspect of the invention there is provided a method of preparing the present formulation comprising the following steps:

(a) providing the silicate;
(b) dispersing the silicate in a solvent; preferably water, for example deionized or distilled water.

In a sixth aspect of the invention there is provided a use of the present cleaning formulation for cleaning a surface, wherein the surface preferably comprises metal, ceramic, enamel, varnished or sealed surfaces, painted surfaces, plastic, leather, glass or wood, preferably belonging to a vehicle.

In a seventh aspect of the invention, there is provided a kit for the cleaning of a surface, especially the external or internal surface of a vehicle, comprising a container which contains the present cleaning formulation and at least one microfiber cloth.

### DETAILED DESCRIPTION OF THE INVENTION

The present invention provides a waterless cleaning solution which has improved temperature stability. Such a cleaning solution can be shipped around the world or stored by consumers in most environments as well as used in different environmental conditions without fear of significant degradation or loss of efficacy.

The invention also aims to provide improved viscosity profile, which renders the waterless cleaning formulation particularly effective. In particular the viscosity is desirably in a practical range for application by consumers, and the formulation has good spreadability at the same time as good cleaning and suspending properties. The viscosity of the formulation is very important, and it has a great influence on the addition of other ingredients, such as water quality requirements and other ingredients, without excessive addition of surfactant.

The invention also aims to provide excellent cleaning properties including improved shine on the cleaned surface.

In addition, the solution does not require any additional water to carry out its cleaning function beyond that which may already be contained in the solution.

The applicant has discovered that the types of silicates used in the present invention are particularly good at providing the cleaning formulation with the appropriate viscosity profile while also providing excellent temperature stability. In particular, any decrease in viscosity of the cleaning formulation upon exposure to increased temperature is negligible in comparison to prior art cleaning formulations. It is important to note that the observed decreases in viscosity in prior art formulations after being exposed to increased temperature were irreversible. Therefore, this problem cannot be solved simply by reducing the temperature of the cleaning formulation.

According to the third aspect of the invention, there is provided a formulation for cleaning comprising solvent (preferably water), silicate present in an amount in the range 0.01 to 1.5 wt % and at least one polymer, wherein the formulation has a viscosity of at least 20 mPa·s, preferably at least 28 mPa·s. The applicant has identified this viscosity range as being particularly well suited for cleaning the hard surfaces described previously. Through the use of silicates, the viscosity loss due to storage at increased temperatures (such as when shipping the formulations across the world) is mitigated. Preferably the silicate is as in the first or second aspect of the invention.

In general, it is favourable when the cleaning formulation has a viscosity of at least 20 mPa·s, and preferably at least 28 mPa·s. The applicant has found that formulations having this minimum level of viscosity are particularly good at lifting dirt from a contaminated surface. Although viscosities lower than these values are not claimed as part of the second aspect of the invention, that is not to say that formulations having such viscosities would not be useful in certain situations. For reference, the viscosity of water is about 0.9 mPa·s at 25° C.

Viscosity is determined at 20° C. and 30 rpm on a viscometer. 30 rpm may correspond to 11.3 cm/s

In general it is important that the viscosity of the cleaning formulation should be greater than that of water. This enables the cleaning formulation to pull sufficient amounts of dirt from the dirty surface.

At the other end of the scale, it is advantageous when the viscosity of the cleaning formulation is not too high, otherwise the user may find it difficult to work with the cleaning formulation. The applicant has found that preferably, the cleaning formulation will have a viscosity of up to 100 mPa·s, more preferably up to 75 mPa·s, and most preferably up to 45 mPa·s. In this way, a balance is achieved between the cleaning ability of the formulation and its usability.

A particularly preferred viscosity range for the cleaning formulation is between 28 mPa·s and 45 mPa·s.

At this stage, the applicant wishes to remark on the measurement of the viscosity. It is well known to the skilled person that viscosity of a solution varies with temperature. In particular, viscosity of a liquid will often decrease when the temperature is increased.

For the present invention, the viscosity of a cleaning formulation will be that measured at around 20° C. It is most advantageous if a suitable viscosity is achieved for all temperatures at which the cleaning formulation might be expected to be used. For water-based cleaning formulations, this will usually be in the temperature range from −20° C. up to around 60° C., although narrower ranges within which the suitable viscosity is achieved are also acceptable, such as 0° C. to 50° C., or 5° C. to 35° C. The point is that the cleaning formulation has the required viscosity when the user goes to use it.

In use, it is conceivable that the cleaning solution would be exposed to temperatures ranging from around −20° C. to around 60° C. The latter is the maximum temperature that one would realistically expect the interior of a car to reach on a hot day. Thus in the method of cleaning according to the invention and the use according to the invention it is preferred that the viscosity is in the preferred ranges as discussed above when at the preferred ranges of temperature discussed above.

A working temperature range is defined as 5 to 35° C. This temperature range is the range that a cleaning formulation is most likely to be exposed to.

In a particularly favourable embodiment, the formulation is thixotropic.

Thixotropy is a time-dependent shear-thinning property of a liquid. Thixotropic liquids will experience a decrease in viscosity as they are subjected to a force. Once this force is removed, the viscosity increases again—not instantaneously, but over a certain period of time. This is due to the rebuilding of the microstructure of the liquid that was previously disturbed by application of the force. Such a force might be the force associated with applying the liquid to a surface, for instance, or pouring it out of a container. Silicates exhibit thixotropic behaviour.

It is advantageous that the cleaning formulation be thixotropic, or exhibit thixotropic behavior, at least in the temperature range at which the cleaning formulation will typically be used. This allows the formulation to initially spread easily on a surface to be cleaned when it is applied to that surface, since the viscosity will initially be low due to shear thinning. This spreading allows the cleaning formulation to fully encapsulate dirt particles and create an even layer on the surface.

However, a short time after the cleaning formulation has been applied to the surface, its viscosity will increase again (due to its thixotropic characteristics). This increase in viscosity allows dirt present on the surface to be easily pulled off the surface when the cleaning formulation is removed. It also makes dripping and pooling of the cleaning formulation less likely and thereby reduces waste.

The yield value is an index to measure the damage resistance of the colloidal structure, that is, the force required to destroy the colloidal structure. The larger the yield value, the more stable the colloidal structure.

In a particularly advantageous embodiment, the silicate is a magnesium lithium silicate, which has been found by the applicant to exhibit thixotropic behavior and also meet the temperature stability and viscosity requirements.

The silicates generally have a layered structure.

Particularly preferable is that the silicate has the chemical formula Li₂Mg₂Si₃O₉. Also known as silicic acid, lithium magnesium salt, it has CAS #37220-90-9. In tests carried out by the applicant, this silicate gave the best balance of temperature stability, thixotropic and viscosity.

Silicates incorporating Na⁺, Li⁺, Mg²⁺ and Al³⁺ are contemplated. Hectorite, CAS #12173-47-6 is also useful.

A further advantage of lithium magnesium silicates is that they are not irritating, they are safe and they are non-toxic. They also yield a transparent or highly translucent solution, which is favourable from a visual and aesthetic perspective.

Magnesium-lithium silicate gels also have the ability to transfer yield values at low viscosity, so the stability of the dispersed phase is possible even in thin fluids, which is valuable compared with most organic thickened rheotropic agents. The colloidal structure of magnesium-lithium silicate gel dispersions also provides the best suspension for other fine particles in the same system, preventing the particles from settling and caking, and ensuring the uniformity of the water system ingredients. The high yield value of the dispersed liquid makes the suspension efficiency better than the organic thickener with the same viscosity.

As discussed previously, the cleaning formulation should have a good balance between cleaning ability and usability—in other words, its viscosity should be neither too high nor too low. To achieve this, in some embodiments the silicate may be present in an amount of 1 wt % or less, preferably 0.5 wt % or less and most preferably 0.3 wt % or less relative to the cleaning formulation. It is noted that the silicate is not the only formulation ingredient that could impact the viscosity, but the silicate will preferably be present in these amounts.

In preferred embodiments of the cleaning formulation, the silicate is present in an amount of at least 0.02 wt %, which the applicant finds to give a desirable minimum viscosity level.

The applicant has determined that a particularly desirable balance of viscosity and usability is achieved when the silicate is present in an amount between at least 0.02 wt % and up to 0.3 wt %.

In preferred embodiments of the cleaning formulation, the solvent comprises water. Preferably the formulation comprises greater than 95% water and more preferably greater than 99% water. Preferably, the water is deionized or distilled water. Using distilled water ensures that essentially no contaminants or ions are introduced into the cleaning formulation, which could affect the cleaning ability of the formulation. Deionised water is better than normal tap water because it does not contain any “hard” ions. Water is preferred because it is environmentally friendly and safe and can be disposed of easily.

The solvent may additionally comprise one or more of an alcohol such as ethanol, glycerol, propylene glycol and polyethylene glycol. For example, lithium magnesium silicate dispersions can be mixed with water-soluble solvents such as 20% ethanol, 50% glycerin, 30% propylene glycol and polyethylene glycol. However, preferably water is the only solvent used in the cleaning formulation.

Preferably the solids content of the composition (namely, total components excluding solvent) is not more than 10 wt %, preferably not more than 5 wt %, more preferably not more than 1 wt %.

It is highly preferred that the cleaning solution be environmentally friendly and not contaminate existing water supplies. For this reason, it is highly advantageous if the cleaning formulation contains no added phosphates. It is also desirable that the cleaning formulation contain no added nitrates. Preferably, the cleaning formulation contains no added amines. Furthermore, the cleaning formulation should ideally contain no added nitrogenous compounds. Preferably, to avoid degradation of the solution itself, or to avoid irritation or toxicity to users, the formulation preferably does not contain highly electrophilic groups such as aldehydes and/or oxidising agents and/or organic halides. Equally, it is also preferable that the cleaning formulation does not contain highly nucleophilic compounds, such as nucleophilic sulphur species or nucleophilic nitrogen species. Compounds such as alcohols are acceptable.

Advantageously, the cleaning formulation may comprise one or more surfactants. Surfactants allow the cleaning formulation to dissolve grease and oils present on a surface to be cleaned. The surfactant may be any surfactant generally known in the art.

Preferably, at least one surfactant has a hydrophilic-lipophilic balance of at least 20, preferably at least 30, and even more preferably at least 38. The hydrophilic-lipophilic balance of a surfactant is a measure of the degree to which it is hydrophilic or lipophilic. Preferred embodiments of the cleaning formulation will use water as a solvent, so a formulation in which the surfactant is highly soluble (having a greater hydrophilic-lipophilic balance) is advantageous in these cases.

In some embodiments, at least one surfactant is a water-soluble salt or acid of the formula ROSO₃, wherein R preferably is a C7-C24 hydrocarbyl, preferably an alkyl or hydroxyalkyl having a C7-C24 alkyl component, more preferably a C12-C18 alkyl or hydroxyalkyl, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperidinium cations and quaternary ammonium cations derived from alkylamines such as ethylamine, diethylamine, triethylamine, and mixtures thereof.

The applicant has determined that advantageously, the formulation comprises sodium dodecyl sulfate as a surfactant. This is a readily available, highly water soluble and effective surfactant. It is also compatible with anionic and non-ionic surfactants. It has good performance in emulsification, permeation, cleaning and dispersion.

At least one surfactant may be a water-soluble salt or acid of the formula RO(A)ₘSO₃X, wherein R is an unsubstituted C10-C24 alkyl or hydroxyalkyl group having a C10-C24 alkyl component, preferably a C12-C20 alkyl or hydroxyalkyl, more preferably C12-C18 alkyl or hydroxyalkyl, A is an ethoxy or propoxy unit, m is greater than zero, typically between about 0.5 and about 6, more preferably between about 0.5 and about 3, and X is H or a cation which can be, for example, a metal cation (e.g., sodium, potassium, lithium, calcium, magnesium, etc.), ammonium or substituted-ammonium cation.

Preferably, the surfactant is present in an amount between 0.05 and 0.075 wt %.

In advantageous embodiments, the cleaning formulation may further comprise a polymer, preferably a polymer that is soluble and/or swellable in the solvent, such as carboxymethyl cellulose, and/or substituted/unsubstituted polyacrylate and/or polyether. Such a substance may perform a variety of functions.

It may act to further thicken the cleaning formulation, contributing to an increased viscosity. In this way, it may be possible to use a reduced amount of the silicate, for example.

It may also act as a flocculating agent, causing fine particulates to clump together and improving the cleaning ability of the cleaning formulation.

Another benefit may be that it improves the ability of the cleaning formulation to form a film over the surface that has been cleaned, which protects the surface and also provides a certain level of shine.

It may also act to reduce residual marks left by water, as the protective layer left behind by the cleaning formulation prevents these marks from forming.

The most preferred shining agent polymer is polyethylene, oxidised—CAS #68441-17-8. Oxidised polyethylene is beneficial because it is non-toxic, resistant to bacterial degradation and provides a visually pleasing (as well as protective) sheen after use. Oxidised polyethylene also has good temperature stability. When acting as a shining agent, oxidised polyethylene does not leave residual marks.

Carboxymethylcellulose is another example of a suitable polymer. Sodium carboxymethyl cellulose provides a homogeneous and stable emulsion. It plays the role of flocculation, chelation and emulsification, increases the lubrication degree (lubricity) of the cleaning solution, and allows the cleaning solution to be wiped more conveniently.

Lubricity is a measure of the ability of a substance to act as a lubricant. It is not the same as the viscosity—indeed, it is possible for two substances of identical or very similar viscosity to have different lubricities. Lubricity of a substance may be measured by assessing the amount of wear that occurs between two parts when that substance acts as a lubricant between those parts. A higher lubricity means that dirt on a surface will glide over that surface more readily without scratching it. To achieve the appropriate lubricity, preferably, the polymer is present in an amount between 0.5 wt % and 0.1 wt %.

Where both carboxymethylcellulose and oxidised polyethylene are present in the cleaning formulation, favourable properties are obtained where carboxymethylcellulose is present in an amount between 0.05 wt % and 0.1 wt % and/or oxidised polyethylene is present in an amount between 0.01 wt % and 0.1 wt %.

In order to adjust the pH, the cleaning formulation may further comprise an acid, such as an organic acid, for example citric acid. It is highly preferable that the cleaning formulation has a pH of between 6 and 8, more preferably between 6.5 and 7.5 and most preferably between 7.0 and 7.2. A pH closer to neutral is less corrosive and is kind to skin. Furthermore, the applicant has found that the viscosity of the cleaning formulation generally peaks in this pH region—generally, at or close to pH 7. Lower viscosities are seen for solutions having a more alkaline pH, and even lower viscosities are seen for solution having an acidic pH.

A particularly favourable embodiment of the invention provides a cleaning formulation consisting essentially of:

water;
lithium magnesium silicate hydrate or a silicate of formula H₂LiMgNaO₁₂Si₄ (CAS #37220-90-9);
polyethylene, oxidised (CAS #68441-17-8);
M-carboxymethylcellulose (preferably sodium carboxymethyl cellulose, CAS #9004-32-4);
M-dodecyl sulphate (preferably sodium dodecyl sulphate, CAS #151-21-3);
M-carbonate (preferably sodium carbonate, CAS #497-19-8);
M-citrate (preferably sodium citrate, CAS #77-92-9);
wherein M is at least one type of counter ion.

By “consisting essentially of” is meant that no other components are intentionally added. Small amounts of impurities may be present, but generally speaking, such a formulation will contain only the above ingredients. In such a formulation, it is desirable if the only counter ion present in solution is essentially sodium. This means that besides impurities, no other counter ions are present or intentionally added. (It is noted that this does not mean that the silicate may only contain sodium ions.)

In other embodiments, the only counter ions present will be ones that do not have a disadvantageous effect on the cleaning ability of the cleaning formulation. For example, no “hard” ions will be present (where the word hard is understood to mean ions associated with hard water, such as calcium and magnesium. This does not apply to the silicate itself in cases where the silicate itself contains magnesium or calcium ions).

It is acceptable for other additives to be present in the solution as an additional thickener or lubricity agent. Examples of other additives that are acceptable additional viscosity increasing agents are montmorillonite (organic bentonite), hectorite, fumed silica, methyl cellulose, hydroxypropyl methylcellulose, hydroxyethyl cellulose, polyvinylpyrrolidone, polyvinylalcohol, polyacrylamide, polyethylene wax, (sodium) polyacrylate), polyurethane and polyethylene oxide. Particularly suitable are hectorite, fumed silica, methyl cellulose, hydroxypropyl methylcellulose, hydroxyethyl cellulose, polyvinylpyrrolidone, polyvinylalcohol, polyacrylamide, polyethylene wax, (sodium) polyacrylate), polyurethane and polyethylene oxide. Of these, the additives that have most beneficial temperature stability are, fumed silica, polyvinyl alcohol, polyvinyl pyrrolidone, polyethylene oxide, polyurethane and polyethylene. The cleaning formulation may additionally comprise one or several of these compounds.

The cleaning formulation may comprise an additional shining agent. This is a substance that is able to produce a shine or sheen on a surface. Shine on a surface typically arises in that a substance is able to fill in small gaps, scratches, cracks or holes on the surface, thereby making the surface smoother. A smoother surface reflects light more consistently and therefore appears shinier. A shining agent will therefore be a substance that can achieve this result.

One example of an additional shining agent is a wax.

Alternatively or additionally, the shining agent may comprise a salt or acid, for example a sodium salt, of a substituted or unsubstituted alkyl carboxylate, wherein the number of carbon atoms in the alkyl chain is between 16 and 22, preferably between 17 and 19, more preferably 18.

The alkyl carboxylate may be substituted with at least one additional hydrophilic group, for example a hydroxy group, preferably at one or more of carbons 11, 12 and/or 13, most preferably carbon 12. In particular, the alkyl carboxylate may be 12-hydroxyoctadecanoate, preferably the sodium salt thereof.

The cleaning formulation may further comprise a source of sodium ions, such as sodium carbonate. This compound plays two roles in the inventive cleaning formulation:

1. It acts together with the surfactant to form an enhanced detergent.

2. Increases the concentration of Na⁺ in the formulation—the silicate has a more stable viscosity and better temperature resistance with the participation of sodium ions.

A further aspect of the invention provides a method of cleaning a surface, the method comprising the following steps:

providing the cleaning formulation of the invention;
applying the undiluted cleaning formulation to the surface.

Preferably the method comprises the following steps:

providing a first microfiber cloth;
contacting the first microfiber cloth with the undiluted cleaning formulation;
and cleaning the surface by contacting the first microfiber cloth with a surface to be cleaned so as to apply the undiluted cleaning formulation to the surface.

Preferably the method further comprises:

providing a second microfiber cloth
rubbing the surface using the second microfiber cloth so as to remove the cleaning formulation and polish the surface to be cleaned.

In the method the first microfiber cloth and the second microfiber cloth comprise fibres, each fibre preferably comprising between 50 and 150 fibrils, e.g. 75 fibrils, preferably wherein the fibres have a widest diameter of between 0.2 and 1 micrometres.

The surface is a hard surface and preferably comprises metal, ceramic, enamel, varnished or sealed surfaces, painted surfaces, plastic, leather, glass or wood.

Preferably the surface is an external surface of a vehicle such as a car. However, the surface can be an internal surface of a vehicle.

The use of a microfiber cloth has several special advantages. Firstly, such a cloth is especially soft and will not scratch the surface that is being cleaned. This is especially important when the surface is the paintwork of a car, for instances.

Secondly, the microfibers of the cloth (as opposed to the “macrofibres” of a standard, non-microfiber cloth) facilitate the capture of dirt, grit and sand particles. The tiny fibres are able to bury the parties deep within the cloth structure. This enables the effective removal of dirt and also prevents dirt escaping, such that it can either be deposited back onto the clean surface or be dragged along the surface by the cloth and scratch it.

Thirdly, it is believed that the microfibers facilitate an electrostatic interaction between the cleaning solution and the fibres. This further improves the ability of the cloth to lift dirt from the surface to be cleaned.

The method may comprise the additional step of removing the cleaning formulation and polishing the surface using a second microfiber cloth directly after contacting the first microfiber cloth with the surface to be cleaned. In this way, the cleaning solution is not left to sit on the surface—instead, the solution and encapsulated dirt is quickly removed. This reduces unnecessary loss of the cleaning solution through evaporation. It also allows contemporaneous shining or buffing of the surface, such that this does not have to follow in a separate step or with a separate shining formulation.

The applicant has found that a favourable microfiber cloth construction is one wherein the first microfiber cloth and the second microfiber cloth comprise fibres, each fibre comprising between 100 and 150 fibrils, preferably wherein the fibres have a widest diameter of between 0.2 and 1 micrometres. Such a cloth has increased surface area of the fiber (up to 50 times greater than a normal towel), which increases the porosity in the fabric. This allows rapid and significant absorption of the cleaning solution.

The microfiber cloth preferably comprises at least two different materials, for example polyester and chinlon. The majority of the microfiber cloth (greater than 50%, and preferably around 80%) comprises polyester and the remainder chinlon.

Polyester has high strength and the chinlon absorbs well. By blending the fabric with high strength and good water absorption, the towel has a good water absorption rate. In some cases this is around 11.4 times, for example.

Fibres used in the towel may be described with the code 160D75F. 160D indicates fiber fineness; 75F means that one fiber contains 75 fine fibers.

The towel is woven by a weaving brush, shaped, softened, double-sided composite, and seamed.

Alternatively, the microfiber towel is composed of around 80% dacron (polyethylene terephthalate), which is strong, and 20% chinlon (a type of nylon), which is highly absorbent.

A container in which the formulation is held, and one or more cloths as discussed above, can be provided as a kit.

A further aspect of the invention provides a method of preparing the formulation described herein comprising the following steps:

(a) providing a silicate of formula H₂LiMgNaO₁₂Si₄ or a silicate of formula M_{w}EₓSi_{y}O_{z}.aH₂O, wherein M is an alkali metal and E is an alkaline earth metal, wherein w, x, y and z are all integers greater than 0 and wherein a is zero or an integer greater than zero;
(b) dissolving or dispersing the silicate in a solvent; preferably water, for example deionized or distilled water;
wherein the silicate is present in an amount in the range 0.01 to 1.5 wt %.

To make some embodiments of the cleaning formulation, a user may weigh the appropriate amount of silicate, and if present, polymer, surfactant (sodium dodecyl sulfate) and any other components present (e.g. sodium carbonate). The materials are mixed and solvent is added (such as water), maintaining stirring to ensure the materials are dissolved fully. Appropriately increasing the water temperature can accelerate the dissolution rate, but the highest water temperature should preferably not exceed 50° C. In addition, it is preferred that the containers and the mixing equipment allowed to contact the liquid are non-metallic. The pH value will be around 8.5 at the end of mixing but a small amount of acid (such as citric acid) can be added into the liquid to adjust the pH, preferably to around 7.0 to 7.2.

A fifth aspect of the invention provides using the cleaning formulation described herein for cleaning a surface, wherein the surface preferably comprises metal, ceramic, enamel, varnished or sealed surfaces, painted surfaces, plastic, leather, glass or wood, preferably belonging to a vehicle.

### Example According to Invention

| CAS No: | Name | Amount |
|---|---|---|
| 37220-90-9 | magnesium lithium silicate | 0.02-0.30% |
| 68441-17-8 | Polyethylene, oxidised | 0.01-0.10% |
| 151-21-3 | Sodium dodecyl sulfate | 0.05-0.075% |
| 9004-32-4 | Carboxymethylcellulose sodium | 0.05-0.1% |
| 497-19-8 | Sodium carbonate | 0.05-0.1% |
| 77-92-9 | Citric Acid | Adjust pH 7.0-7.1 |
| 7732-18-5 | Deionized water | 99.82-99.325% |

The applicant's testing of viscosity-increasing agents/thickeners show that the viscosity of a liquid suspension of lithium magnesium silicate hydrate at a concentration of 1 g/L does not drop below 35 mPa·s even after 40 days when held at a temperature of 20° C. Further, upon subjection to temperatures of up to 60° C. for 24 hours, the viscosity of said solution did not drop below around 33 mPa·s. Where the lithium magnesium silicate hydrate is used, this means the hydrate having 50 g water per 1000 g of compound. However, it is not considered essential that the hydrate be used and it is contemplated that the anhydrous form would work just as well.

In contrast, prior art solutions containing, instead of the silicate, polyacrylate at a concentration of 1 g/L were found to exhibit less advantageous properties. Such a solution displayed a marked decrease in viscosity after 40 days held at 20° C. (viscosity decreased from around 38 mPa·s to around 9 mPa.$). Heating at 60° C. for 5 hours resulted in a further decrease in the viscosity towards that of water.

Poly(N-isopropyl-acrylamide) at 1 g/L exhibited a viscosity decrease from around 38 mPa·s to around that of water after only 7 days at 20° C.

Methyl cellulose at 1 g/L exhibited a decrease in viscosity from around 18 mPa·s to around 11 mPa·s after 40 days at 20° C. At temperatures above 45° C., this solution exhibited thermosetting behaviour, resulting in a drastically increasing viscosity to greater than 40 mPa·s.

### DESCRIPTION OF THE FIGURES

FIG. 1 shows a temperature-viscosity relationship for a prior art formulation containing sodium polyacrylate as the main thickening agent. The temperature increase causes a permanent and large reduction in the viscosity.

FIG. 2 shows the viscosity change of the present inventive cleaning formulation at different temperatures. It is clear that the viscosity profile is more stable at increased temperatures in comparison to prior art formulations. If desired, the viscosity can be appropriately increased during the manufacturing process to compensate for the viscosity loss caused by higher temperatures during marine transportation. However, as the viscosity loss is not particularly large, any increase in viscosity in the manufacturing process would not need to be particularly large either.

FIG. 3 shows the variation in viscosity with temperature measured for lithium magnesium silicate hydrate in water measured at a concentration of 1 g/L. This gives an acceptable viscosity for cleaning in all working temperature ranges.

FIG. 4 shows the variation in viscosity with temperature measured for sodium polyacrylate (used in prior art formulations) measured at a concentration of 1 g/L. While the viscosity is initially acceptable, at higher temperatures it deteriorates to unacceptable levels.

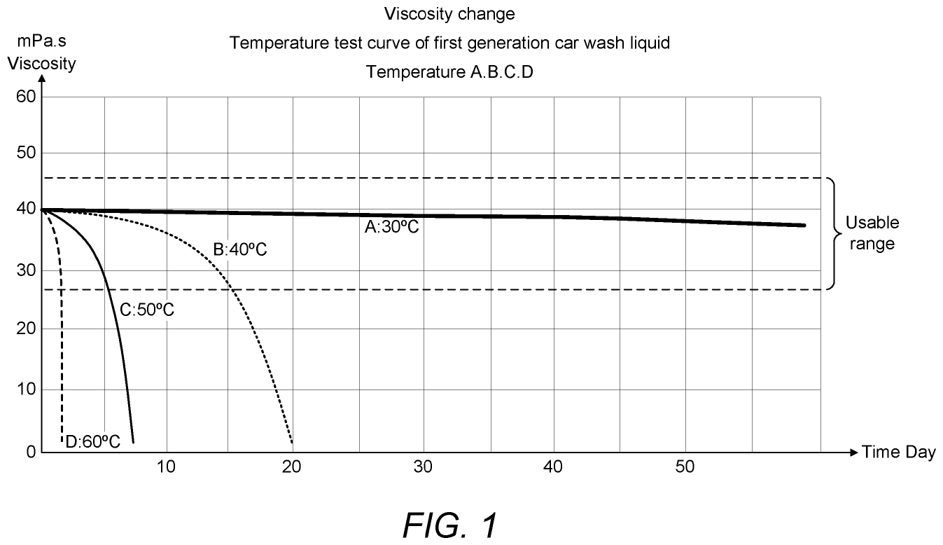

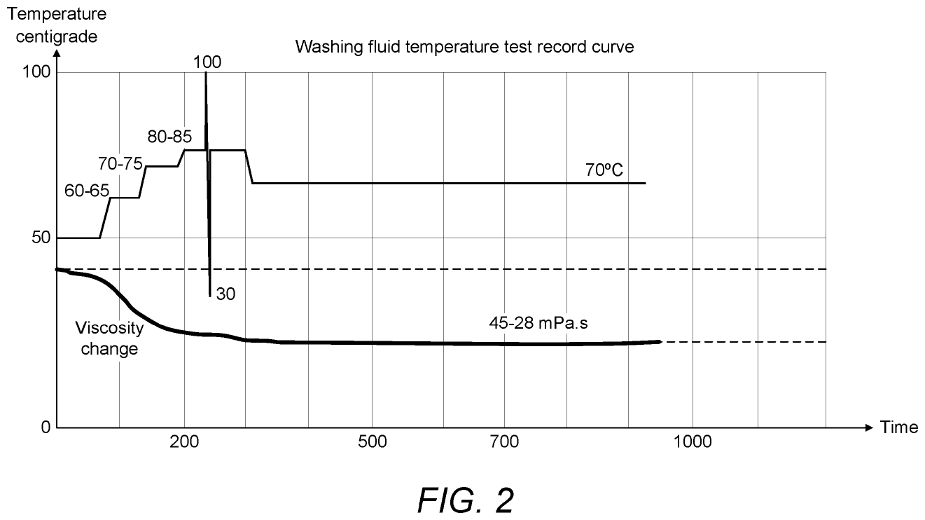

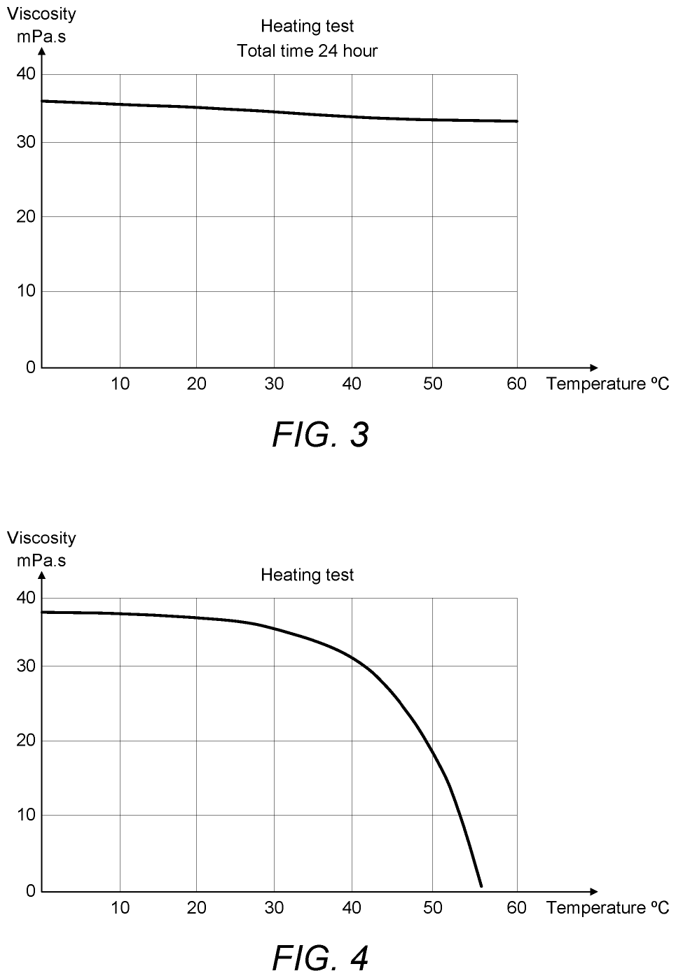

Embodiment 1: A formulation for cleaning comprising:

solvent;
silicate selected from magnesium lithium silicates and mixtures thereof;
wherein silicate is present in a total amount in the range 0.01 to 1.5 wt %.

Embodiment 2: A formulation for cleaning comprising:

solvent;
silicate selected from the group consisting of
silicate of formula H₂LiMgNaO₁₂Si₄,
silicate of formula M_{w}EₓSi_{y}O_{z}.aH₂O, wherein M is an alkali metal and E is an alkaline earth metal;
wherein w, x, y and z are all numbers greater than 0 and wherein a is 0 or an number greater than 0;
and mixtures thereof;
wherein silicate is present in a total amount in the range 0.01 to 1.5 wt %.

Embodiment 3: A formulation for cleaning comprising:

solvent, preferably water;
silicate present in an amount in the range 0.01 to 1.5 wt %;
at least one polymer;
wherein the formulation has a viscosity of at least 20 mPa·s, preferably at least 28 mPa·s, measured at a shear rate of 11.3 cm/s and a temperature of 20° C.

Embodiment 4: The formulation of any of the preceding embodiments, having a viscosity of up to 100 mPa·s, preferably up to 75 mPa·s, more preferably up to 45 mPa·s.

Embodiment 5: The formulation of any of the preceding embodiments, wherein the formulation is thixotropic.

Embodiment 6: The formulation of any of the preceding embodiments, wherein the silicate comprises silicate of formula M_{w}EₓSi_{y}O_{z}.aH₂O wherein M=Li and E=Mg, preferably also wherein w=2, x=2, y=3 and z=9.

Embodiment 7: The formulation of any of the preceding embodiments, wherein the silicate comprises magnesium lithium silicate CAS #37220-90-9, preferably wherein the silicate consists essentially of magnesium lithium silicate CAS #37220-90-9.

Embodiment 8: The formulation of any of the preceding embodiments, wherein silicate is present in an amount of 1 wt % or less, preferably 0.5 wt % or less, most preferably 0.3 wt % or less relative to the cleaning formulation.

Embodiment 9: The formulation of any of the preceding embodiments, wherein silicate is present in an amount of at least 0.02 wt %.

Embodiment 10: The formulation of any of the preceding embodiments, wherein the solvent is water and the composition preferably comprises at least 95% water, preferably at least 99% water, wherein the water is preferably deionized or distilled water.

Embodiment 11: The formulation of any of the preceding embodiments, further comprising one or more surfactants.

Embodiment 12: The formulation of embodiment 11, wherein at least one surfactant has a hydrophilic-lipophilic balance HLB of at least 20, preferably at least 30, and even more preferably at least 38.

Embodiment 13: The formulation of embodiment 11 or 12, wherein at least one surfactant is a water-soluble salt or acid of the formula ROSO₃M, wherein R preferably is a C₇-C₂₄ hydrocarbyl, preferably an alkyl or hydroxyalkyl having a C₇-C₂₄ alkyl component, more preferably a C₁₂-C₁₈ alkyl or hydroxyalkyl, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperidinium cations and quaternary ammonium cations derived from alkylamines such as ethylamine, diethylamine, triethylamine, and mixtures thereof.

Embodiment 14: The formulation of any of the preceding embodiments, wherein the formulation comprises sodium dodecyl sulfate.

Embodiment 15: The formulation of any of embodiments 11 to 14, wherein at least one surfactant is a water-soluble salt or acid of the formula RO(A)ₘSO₃X, wherein R is an unsubstituted C₁₀-C₂₄ alkyl or hydroxyalkyl group having a C₁₀-C₂₄ alkyl component, preferably a C₁₂-C₂₀ alkyl or hydroxyalkyl, more preferably C₁₂-C₁₈ alkyl or hydroxyalkyl, A is an ethoxy or propoxy unit, m is greater than zero, typically between about 0.5 and about 6, more preferably between about 0.5 and about 3, and X is H or a cation which can be, for example, a metal cation (e.g., sodium, potassium, lithium, calcium, magnesium, etc.), ammonium or substituted-ammonium cation.

Embodiment 16: The formulation of any of embodiments 11 to 15, wherein the surfactant is present in an amount from 0.05 to 0.075 wt %

Embodiment 17: The formulation of any of the preceding embodiments, further comprising a polymer.

Embodiment 18: The formulation of embodiment 17, wherein the polymer comprises sodium carboxymethyl cellulose.

Embodiment 19: The formulation of embodiments 17 or 18, wherein the polymer comprises oxidised polyethylene CAS #68441-17-8, preferably having an average molecular weight of from 1,000,000 to 2,000,000 Da.

Embodiment 20: The formulation of any of the preceding embodiments, wherein sodium carboxymethylcellulose is present in an amount from 0.05 wt % to 0.1 wt % and/or polyethylene oxide is present in an amount from 0.01 wt % to 0.10 wt %.

Embodiment 21: The formulation of any of the preceding embodiments further comprising an organic acid, preferably citric acid.

Embodiment 22: The formulation of any of the preceding embodiments having a pH of from 6 to 8, preferably from 6.5 to 7.5, more preferably between 7.0 and 7.2.

Embodiment 23: A cleaning formulation according to any of the preceding embodiments consisting essentially of:

water;
magnesium lithium silicate CAS #37220-90-9;
oxidised polyethylene CAS #68441-17-8;

### M-carboxymethylcellulose

M-dodecyl sulfate;

### M-carbonate;

### M-citrate,

wherein M is at least one type of counter ion.

Embodiment 24: The formulation of embodiment 23, wherein the counter ion is only sodium.

Embodiment 25: A method of cleaning a surface, the method comprising the following steps:

(a) providing the cleaning formulation of any of the preceding Embodiments;
(b) applying the undiluted cleaning formulation to the surface.

Embodiment 26: The method of embodiment 25, comprising the following steps:

(a1) providing a first microfiber cloth;
(a2) contacting the first microfiber cloth with the undiluted cleaning formulation; and
(c) cleaning the surface by contacting the first microfiber cloth with a surface to be cleaned so as to apply the undiluted cleaning formulation to the surface.

Embodiment 27: The method of embodiment 25 or embodiment 26, further comprising:

(d) providing a second microfiber cloth
(e) rubbing the surface using the second microfiber cloth so as to remove the cleaning formulation and polish the surface to be cleaned.

Embodiment 28: The method of embodiment 27 wherein the first microfiber cloth and the second microfiber cloth comprise fibres, each fibre comprising between 50 and 150 fibrils, preferably around 75 fibrils, preferably wherein the fibres have a widest diameter of between 0.2 and 1 micrometres.

Embodiment 29: The method of any of embodiments 25 to 28 wherein the surface comprises metal, ceramic, enamel, varnished or sealed surfaces, painted surfaces, plastic, leather, glass or wood.

Embodiment 30: The method of any of embodiments 25 to 29 wherein the surface is an external surface of a vehicle.

Embodiment 31: The method of embodiment 30 wherein the amount of the cleaning formulation used is in the range 200 to 1000 ml, preferably in the range 300 to 500 ml.

Embodiment 32: The method of any of embodiments 25 to 31 wherein the surface is an internal surface of a vehicle.

Embodiment 33: A method of preparing the formulation of any of embodiments 1 to 24 comprising the following steps:
(a) providing the silicate;
(b) dispersing the silicate in a solvent; preferably water, for example deionized or distilled water.

Embodiment 34: Use of the cleaning formulation of one of embodiments 1 to 24 for cleaning a surface, wherein the surface preferably comprises metal, ceramic, enamel, varnished or sealed surfaces, painted surfaces, plastic, leather, glass or wood, preferably belonging to a vehicle.

Embodiment 35: The use of embodiment 34 wherein the surface is an external surface of a vehicle.

Embodiment 36: The use of embodiment 34 wherein the surface is an internal surface of a vehicle.

Embodiment 37: A kit for the cleaning of a surface, especially the external or internal surface of a vehicle, comprising a container which contains a cleaning formulation according to any of embodiments 1 to 24 and at least one microfiber cloth.

Embodiment 38: A kit according to embodiment 37 comprising two microfiber cloths, preferably wherein the two cloths are of different structure.

1. The formulation of claim 3, comprising:
one or more surfactants;
the silicate selected from magnesium lithium silicates and mixtures thereof;
wherein the silicate is present in a total amount in the range 0.01 to 0.5 wt %.

2. The formulation of claim 3, comprising:
the silicate selected from the group consisting of:
silicate of formula H₂LiMgNaO₁₂Si₄;
silicate of formula M_{w}EₓSi_{y}O_{z}.aH₂O, wherein M is an alkali metal and E is an alkaline earth metal;
wherein w, x, y and z are all numbers greater than 0 and wherein a is 0 or a number greater than 0;
and mixtures thereof.

3. A formulation comprising:
solvent;
silicate present in an amount in the range 0.01 to 1.5 wt %; and
at least one polymer;
wherein the formulation has a viscosity of at least 20 mPa·s measured at a shear rate of 11.3 cm/s and a temperature of 20° C.

4. The formulation of claim 3, having a viscosity of up to 100 mPa·s.

5. The formulation of claim 3, wherein the formulation is thixotropic.

6. The formulation of claim 3, wherein the silicate comprises silicate of formula M_{w}EₓSi_{y}O_{z}.aH₂O wherein M=Li and E=Mg.

7. The formulation of claim 3, wherein the silicate comprises magnesium lithium silicate CAS #37220-90-9.

8. (canceled)

9. (canceled)

10. The formulation of claim 3, wherein the solvent is water.

11. The formulation of claim 3, further comprising one or more surfactants.

12. The formulation of claim 11, wherein at least one surfactant has a hydrophilic-lipophilic balance HLB of at least 20.

13. The formulation of claim 11, wherein at least one surfactant is a water-soluble salt or acid of the formula ROSO₃M, wherein M is H or a cation.

14. The formulation of claim 3, wherein the formulation comprises sodium dodecyl sulfate.

15. The formulation of claim 11, wherein at least one surfactant is a water-soluble salt or acid of the formula RO(A)ₘSO₃X, wherein R is an unsubstituted C₁₀-C₂₄ alkyl or hydroxyalkyl group having a C₁₀-C₂₄ alkyl component, A is an ethoxy or propoxy unit, m is greater than zero.

16. The formulation of claim 11, wherein the surfactant is present in an amount from 0.05 to 0.075 wt %

17. (canceled)

18. The formulation of claim 3, wherein the polymer comprises sodium carboxymethyl cellulose.

19. The formulation of claim 3, wherein the polymer comprises oxidised polyethylene CAS #68441-17-8.

20. (canceled)

21. The formulation of claim 3, further comprising an organic acid.

22. The formulation of claim 3, having a pH from 6 to 8.

23. The formulation of claim 3, comprising:
water;
magnesium lithium silicate CAS #37220-90-9;
oxidised polyethylene CAS #68441-17-8;
M-carboxymethylcellulose
M-dodecyl sulfate;
M-carbonate;
M-citrate;
wherein M is at least one type of counter ion.

24. The formulation of claim 23, wherein the counter ion is only sodium.

25.-38. (canceled)
